(19) United States
(12) Patent Application Publication
(10) Pub. No.: US 2006/0275917 A1
(43) Pub. Date: Dec. 7, 2006

(54) Method for staining and destaining gel, electrophoresis destaining device for gel, and kit for staining and destaining gel

(75) Inventor: Akira Wada, Otsa-shi (JP)

Correspondence Address: HAMRE, SCHUMANN, MUELLER & LARSON, P.C., P.O. BOX 2902, MINNEAPOLIS, MN, 55402-0902, US

(73) Assignee: The Lab. of Bio-Informatics Technology, Kawasaki-shi (JP)

(21) Appl. No.: 11/443,752

(22) Filed: May 31, 2006

(30) Foreign Application Priority Data
Jun. 2, 2005 (JP) 2005-162957

(51) Int. Cl. G01N 1/10

(52) U.S. Cl. 436/174

(57) ABSTRACT

A method for staining and destaining a gel, including: a staining step of staining the gel using an acid aqueous solution that contains a dye and does not contain alcohol; and a destaining step of destaining the dye by electrophoresis by applying a voltage to the gel disposed in an acid aqueous solution that does not contain alcohol. The destaining step can be conducted by using, for example, an electrophoresis destaining device including: a body vessel; a pair of electrodes; and a gel container, wherein the pair of the electrodes and the gel container disposed between the electrodes are arranged in parallel to each other in the body vessel along a spacer of the body vessel.

### BACKGROUND OF THE INVENTION

1. Field of the Invention

The present invention relates to a method for staining and destaining a gel, an electrophoresis destaining device for a gel, and a kit for staining and destaining a gel.

The present disclosure relates to subject matter contained in priority Japanese Application No. 2005-162957, filed on Jun. 2, 2005, which is herein expressly incorporated by reference in its entirety.

2. Description of Related Art

Gel sieving electrophoresis is a technique used generally for separation and analysis of protein and nucleic acid. For separation and analysis of protein, polyacrylamide gel electrophoresis (PAGE) with a crosslinking degree of polyacrylamide gel ranging, for example, from 4% to 20% mostly is used. Moreover, polyacrylamide gel electrophoresis with sodium dodecyl sulfate (SDS) added therein as a denaturant (SDS-PAGE) has an exceedingly high capability of separating protein, and thus is used for measuring the molecular weight of protein and controlling a process of refining protein. Conventionally, for staining protein after polyacrylamide gel electrophoresis, three representative methods including dye staining, silver staining and fluorescent staining are used. Among them, the most common staining method is dye staining, and in particular, a method using Coomassie brilliant blue (hereinafter, also called CBB) most commonly is used. This CBB staining is a staining method of allowing CBB to adhere to protein by intermolecular interaction between the CBB and the protein so as to color the protein. A protocol of a common CBB staining includes: fixing and staining protein on a gel after electrophoresis over about 30 minutes by using a CBB staining solution containing CBB, methanol and acetic acid; and then destaining the gel over about 2 hours to about 16 hours using a destaining solution containing methanol and acetic acid. Maximum detectability of the CBB staining is lower than that of silver staining and the like, but CBB staining has simple operational processes, high quantitativity and high reproducibility (see Patent document 1), and thus is a very important experimental method in the fields of research and development of medical science, pharmaceutical science, biology, bioscience and the like.

Problems of the CBB staining include a long operation time. More specifically, since each of a fixing step, a staining step and a destaining step is conducted by diffusing a reagent such as a stainer into a gel by osmosis, it basically takes time, and generally requires about 2 hours to about 16 hours, as described above. In particular, in the case of using CBB R-250 or CBB G-250 as a dye, destaining of the gel becomes a problem. For example, if a destaining time is short and the destaining is insufficient, the color background of the gel is increased, and it becomes difficult to find a band and a spot of protein. On the contrary, if, for example, a gel is destained overnight, a band and a spot of protein also are destained, and thus additional staining may be required. In addition, although reagents that enable CBB staining and destaining in a short period of time are commercially available, each of these reagents has a low staining degree, which results in a problem that it is difficult to find a band and a spot of protein present in a very small amount.

A method for destaining, by utilizing electrophoresis, a gel that is stained by the dye staining has been suggested as a method for destaining a gel that is stained with amido black which is less sensitive than CBB in staining (see Non-patent document 1).

Patent document 1: JP 2003-29304 A

Non-patent document 1: Katlschimdt, E. & Wittmann, H. G. (1970) Anal. Biochem. 36 p. 401-412

### SUMMARY OF THE INVENTION

However, this method has a problem in that it is effective only for amido black, and CBB cannot be destained efficiently from a gel that is stained by the conventional CBB staining. And so far, a method for destaining CBB by utilizing electrophoresis has not been established in a practical utility level yet. Thus, an object of the present invention is to provide a method for staining and destaining a gel, which includes destaining a dye in the gel by electrophoresis.

In order to attain the above-described object, the method for staining and destaining a gel of the present invention includes: a staining step of staining the gel by using an acid aqueous solution that contains a dye and does not contain alcohol; and a destaining step of destaining the dye by electrophoresis by applying a voltage to the gel disposed in an acid aqueous solution that does not contain alcohol.

The inventors of the present invention found that a reason why CBB cannot be electrophoresed is that, in the conventional CBB staining and destaining method, a gel is stained and destained in an acid solution, and thus the CBB loses an electric charge in this acid solution so as not to be electrophoresed. And, CBB can be electrophoresed in a neutral or basic solution. However, under such a condition, not only CBB that is not adhered to protein but also CBB that is adhered thereto are electrophoresed from the gel without distinction, which results in a new problem of an inability to detect protein. As a result, the inventors of the present invention conducted a keen study to solve this problem, and they found below-described two causes, thus reaching the present invention.

The inventors of the present invention found that, as a first cause, a bond between protein and CBB is unstable in a basic solution. Then, a gel is stained and destained using an acid solution by the conventional method, and before the destaining by electrophoresis, the gel is immersed once in a neutral or basic solution so as to provide the CCB with an electric charge, whereby the CBB can be electrophoresed even in an acid solution. However, according to this method, electrophoresis using an acid solution can be realized, but the problem that CBB is electrophoresed regardless of its adherence to protein still cannot be solved. Then, the inventors of the present invention conducted a further study, and found that, as a second cause, alcohol such as methanol and ethanol fixes proteins, but allows a bond between protein and CBB to be unstable. Then, by eliminating the use of alcohol from all of the steps from staining to destaining, the bond between protein and CBB is stabilized, and distinction of the electrophoresis of CBB according to its adherence to protein can be realized. More specifically, the CBB that is adhered to the protein is not electrophoresed, and only the CBB that is not adhered to the protein is electrophoresed so as to be destained.

In the conventional CBB staining and destaining, the use of alcohol such as methanol has been a common knowledge in the art of biotechnology. The reason for this is because such use of methanol or the like has advantages of improving an efficiency of the staining and the destaining, and an efficiency of fixing protein in a gel. However, according to the method for staining and destaining a gel of the present invention, by eliminating the use of alcohol such as methanol contrarily to the above-described knowledge in the art, an excellent effect of a large reduction of a time required for destaining by electrophoresis can be obtained. Moreover, according to the method for staining and destaining a gel of the present invention, by not using alcohol such as methanol, but by using, for example, a staining solution containing acetic acid or the like, fixing of protein and a degree of staining thereof can be maintained in levels as favorable as those of the conventional methods. Under this condition, CBB itself fixes proteins instead of alcohol.

According to the method for staining and destaining a gel of the present invention, by simple operational processes and reagents, a gel can be stained and destained in a shorter period of time and with reduced operating cost, while maintaining the degree of its staining to be as high as that of the conventional method, for example.

These and other advantages of the present invention will become apparent to those skilled in the art upon reading and understanding the following detailed description with reference to the accompanying figures.

### BRIEF DESCRIPTION OF THE DRAWINGS

FIG. 1 is a schematic view showing an example of the electrophoresis destaining device for a gel of the present invention.

FIG. 2 is a schematic view showing another example of the electrophoresis destaining device for a gel of the present invention.

FIG. 3 is a schematic view showing an example of a gel container of the electrophoresis destaining device for a gel of the present invention.

FIG. 4 shows a photograph of an example of a result obtained by comparing respective methods for staining and destaining a gel (Example 1).

FIG. 5 shows photographs of another example of a result obtained by comparing the respective methods for staining and destaining a gel (Example 2).

### DETAILED DESCRIPTION OF THE INVENTION

It is preferable that the method for staining and destaining a gel of the present invention further includes a destaining-acceleration step between the staining step and the destaining step, and the destaining-acceleration step is a step of immersing the gel after the staining step in an aqueous solution that has a pH of more than 7 and does not contain alcohol.

In the method for staining and destaining a gel of the present invention, it is preferable that each of the aqueous solution in the staining step and the aqueous solution in the destaining step contains acetic acid, and the gel is a polyacrylamide gel. Moreover, it is preferable that the gel contains protein, and the dye is at least one dye selected from the group consisting of: Coomassie brilliant blue G250; Coomassie brilliant blue R250; amido black 10B; ponceau 3R; nigrosine; and a dye having an electric charge. Furthermore, the destaining step further includes stirring the aqueous solution.

The electrophoresis destaining device for a gel of the present invention is an electrophoresis destaining device for a gel to be used in a method for staining and destaining the gel, the electrophoresis destaining device including: a body vessel; a pair of electrodes; and a gel container, wherein the pair of the electrodes are disposed inside the body vessel, and the gel container includes a support for holding the gel by sandwiching the gel, and is disposed detachably between the pair of the electrodes inside the body vessel.

It is preferable that, in the electrophoresis destaining device for a gel of the present invention, the pair of the electrodes and the gel container are arranged so that a direction of a voltage and a normal line of a surface of the gel may be substantially parallel.

It is preferable that the kit for staining and destaining a gel of the present invention is a kit to be used in the method for staining and destaining a gel of the present invention, and the kit includes at least one reagent selected from the group consisting of: the aqueous solutions to be used in the respective steps; concentrates of the aqueous solutions; and powders of components of the aqueous solutions, and a manual for instructing the method for staining and destaining a gel. Moreover, it is preferable that the kit for staining and destaining a gel of the present invention further includes the electrophoresis destaining device for a gel of the present invention.

In the present invention, a “gel” denotes a molecular sieve material for separation analyses of biological substances and chemical substances in the fields of biology, chemistry, medical science, pharmaceutical science, bioscience and the like, and preferably denotes a distribution support of a sample component by an electrophoresis method. The material of the gel is not limited particularly, and may be, for example, conventionally known polyacrylamide, agarose and the like. The gel used in the method for staining and destaining a gel of the present invention is preferably a gel after electrophoresis of protein. According to the method for staining and destaining a gel of the present invention, the protein can be stained in the staining step, and destaining of the dye with which the protein is stained can be suppressed in the destaining step, whereby the method can be used for detecting the protein. However, the application purpose of the method for staining and destaining a gel of the present invention is not limited to these. The electrophoresis of protein is not limited particularly, and may be conventionally known electrophoresis, for example, polyacrylamide gel electrophoresis (PAGE), sodium dodecyl sulfate-added polyacrylamide gel electrophoresis (SDS-PAGE), an O'Farrel's two-dimensional electrophoresis method, a RFHR's two-dimensional electrophoresis method (see JP 6-41933 B) and the like. The size and shape of the gel also are not limited particularly, and may be, for example, a disk-type columnar shape and a slab-type sheet shape.

In the present invention, a “method for staining and destaining a gel” includes a method for staining the gel and a method for destaining the gel after being stained.

In the present invention, “alcohol” is not limited particularly, and includes monovalent alcohol and multivalent alcohol. It preferably is monovalent alcohol, and more preferably is ethanol, methanol or isopropanol.

The method for staining and destaining a gel of the present invention will be described below.

(Staining Step)

Firstly, a gel is stained using an acid aqueous solution that contains a dye and does not contain alcohol (hereinafter, also called a staining solution). The gel is, for example, a gel after electrophoresis of protein, as mentioned above.

The dye denotes a coloring matter that may bond to biological substances and chemical substances such as protein, which are distributed in a gel, and thus can be used to detect them. In the present invention, the dye is destained by electrophoresis, and thus preferably is a molecule that has an electric charge at any pH value. The biological substances and the chemical substances to be stained with the dye are not limited particularly, and may be, for example, protein. The protein includes modified protein such as glycoprotein and lipid protein. Examples of the dye for the protein include: CBB G250; CBB R250; amido black 10B; ponceau 3R; and nigrosine, and among them, CBB is preferable.

Alcohol that should be eliminated from the staining solution is at least ethanol, methanol and isopropanol, preferably is monovalent alcohol, and more preferably is alcohol in general.

The staining solution is acidic, and a pH thereof preferably ranges from 2 to 5, and more preferably ranges from 2 to 3. The pH can be adjusted with, for example, an acid such as acetic acid and phosphoric acid or an acid buffer, but the staining solution preferably contains acetic acid. The reason for this is because acetic acid has an effect of improving a staining efficiency of the dye, stabilizing the dye bound to the protein, and accelerating the fixing of the protein in the gel, and the like. In the case of preparing the staining solution using acetic acid and the dye, a content of the acetic acid ranges, for example, from 10 mL/L to 100 mL/L, preferably ranges from 20 mL/L to 100 mL/L, and more preferably ranges from 20 mL/L to 50 mL/L. A content of the dye ranges, for example, from 0.1 g/L to 100 g/L, preferably ranges from 0.5 g/L to 50 g/L, and more preferably ranges from 1.0 g/L to 10 g/L. The staining solution further may contain boric acid (orthoboric acid) with a content ranging from 0.01 g/L to 1.0 g/L, for example.

A method for preparing the staining solution is not limited particularly. For example, the staining solution may be prepared immediately before its use, or may be obtained by: preparing a concentrate of an acid aqueous solution except the dye in advance; and diluting the concentrate and mixing a predetermined amount of the dye therewith immediately before its use.

A method for staining the gel using the staining solution is not limited particularly, as long as the staining solution can be in contact with the gel, and may be, for example, a method of immersing the gel in the staining solution or the like. In addition, the gel may be stained by, for example, being allowed to stand still while being immersed in the staining solution, or may be stained while being shaken appropriately. An amount of the staining solution to be used is not limited particularly, and it is, for example, 5 times or more, and preferably is 10 times or more a volume of the gel. A staining time ranges, for example, from 5 minutes to 60 minutes, preferably ranges from 10 minutes to 45 minutes, and more preferably ranges from 10 minutes to 30 minutes.

(Destaining-Acceleration Step)

Next, the gel stained in the staining step is immersed in an aqueous solution that has a pH of more than 7 and does not contain alcohol (hereinafter, also called a destaining-acceleration solution). As mentioned above, since CBB is not electrophoresed under an acid condition, the gel is immersed once in the solution that has a pH of more than 7 after being stained using the acid staining solution, so as to further accelerate the subsequent destaining by electrophoresis. This is thought to be because ionization of the CBB in the gel is accelerated, but the present invention is not limited to such a mechanism. In addition, in the case of placing more importance on a destaining time than a destaining efficiency, this destaining-acceleration step can be omitted. For example, in the case of using a very thin gel, it is possible to skip the destaining-acceleration step and proceed to the subsequent destaining step. For decreasing the color background and improving a contrast, however, it is preferable to conduct the destaining-acceleration step.

The pH of the destaining-acceleration solution is more than 7, preferably ranges from 7 to 10, and more preferably ranges from 9 to 10. The pH can be adjusted by using a conventionally known buffer, and for example, a TBE (Tris/boric acid/EDTA) buffer, a TAE (Tris/acetic acid/EDTA) buffer, a Tris/hydrochloric acid/EDTA buffer and the like can be used. The pH can be also adjusted by adding an alkaline substance such as KOH or NaOH to the above buffers. In addition, alcohol that should be eliminated from the destaining-acceleration solution is, for example, monovalent alcohol, and more specifically is ethanol, methanol and isopropanol. A method for preparing the destaining-acceleration solution is not limited particularly. For example, the destaining-acceleration solution may be prepared immediately before its use, may be obtained by: preparing a concentrate thereof in advance; and diluting the concentrate before its use, or may be obtained by: preparing a powder of the components in advance; and dissolving the powder before its use.

An amount of the destaining-acceleration solution to be used is not limited particularly, but is, for example, 5 times or more, and preferably is 10 times or more the volume of the gel. A time of immersing the gel in the destaining-acceleration solution ranges, for example, from 1 minute to 30 minutes, preferably ranges from 5 minutes to 20 minutes, and more preferably ranges from 10 minutes to 15 minutes. The gel may be immersed in the destaining-acceleration solution by, for example, being allowed to stand still while being immersed in the destaining-acceleration solution, or may be immersed while being shaken appropriately.

(Destaining Step)

Finally, the gel after the staining step or the destaining-acceleration step is disposed in an acid aqueous solution that does not contain alcohol (hereinafter, also called a destaining solution), and a voltage is applied thereto so as to destain the dye by electrophoresis.

The destaining solution is acidic, and a pH thereof preferably ranges from 2 to 5, and more preferably ranges from 2 to 3. The pH can be adjusted with, for example, an acid such as acetic acid and phosphoric acid or an acid buffer, but the destaining solution preferably includes acetic acid. The reason for this is because acetic acid has an effect of improving a destaining efficiency of the dye, stabilizing the dye bound to the protein, and accelerating the fixing of the protein in the gel, and the like. In the case of preparing the destaining solution using acetic acid, a content of the acetic acid ranges, for example, from 10 mL/L to 100 mL/L, preferably ranges from 10 mL/L to 50 mL/L, and more preferably ranges from 10 mL/L to 20 mL/L. The destaining solution further may contain boric acid (orthoboric acid) with a content ranging from 0.01 g/L to 1.0 g/L, for example. In addition, alcohol that should be eliminated from the destaining solution is, for example, monovalent alcohol, and more specifically is ethanol, methanol and isopropanol. A method for preparing the destaining solution is not limited particularly. For example, the destaining solution may be prepared immediately before its use, or may be obtained by: preparing a concentrate thereof in advance; and diluting the concentrate immediately before its use.

A method for the electrophoresis is not limited particularly, as long as a voltage can be applied to the gel in the destaining solution, and for example, the electrophoresis destaining device for a gel of the present invention that will be described below can be used. In the case where the gel is, for example, a sheet-shaped gel such as a slab gel, it is preferable that a direction of the voltage to be applied is substantially parallel to a direction of a normal line of a surface of the gel. The reason for this is because, according to such a direction, the dye can be moved outside the gel over a shorter distance. The voltage to be applied preferably is in a range in which the destaining solution is not boiled nor excessively heated, and it ranges, for example, from 50 V to 400 V, and preferably ranges from 100 V to 200 V. The voltage can be applied at a constant voltage by using, for example, a conventionally known power supply. A time of the electrophoresis for destaining the gel can be adjusted appropriately according to a thickness of the gel and a degree of the destaining, and it ranges, for example, from 10 minutes to 30 minutes, and preferably ranges from 10 minutes to 20 minutes. In addition, an amount of the destaining solution to be used is not limited particularly, and it is, for example, 10 times or more, and preferably is 15 times or more the volume of the gel. The gel preferably is destained while stirring the destaining solution appropriately. By stirring the destaining solution, the dye effused from the gel efficiently can be prevented from adhering to the gel again. A means for stirring is not limited particularly, and may be, for example, a stirring bar.

Next, the electrophoresis destaining device for a gel of the present invention will be described. The electrophoresis destaining device for a gel of the present invention can be used for the electrophoresis in the above-described destaining step.

The electrophoresis destaining device for a gel of the present invention includes: a body vessel; a pair of electrodes; and a gel container, wherein the pair of the electrodes are disposed inside the body vessel, and the gel container includes a support for holding the gel by sandwiching it, and is disposed detachably between the pair of the electrodes inside the body vessel. By disposing the gel container in an electric field formed by the pair of the electrodes, the gel in the gel container can be destained.

In the case of destaining a sheet-shaped gel such as a typical slab gel, the pair of the electrodes and the gel container preferably are arranged so that a direction of a voltage and a normal line of a surface of the gel may be substantially parallel. This aims to make the voltage applied to the gel and the destaining thereof more uniform. In this case, the electrodes and the gel container may be disposed perpendicularly to a bottom of the body vessel, or horizontally to the bottom. The number of the gel containers to be disposed in the body vessel is not necessarily one, and a plurality of the gel containers can be disposed so as to destain a plurality of sheets of the gel at the same time. In the case of disposing the plurality of the gel containers, the electrodes and the gel containers preferably are disposed perpendicularly to the bottom of the body vessel. The reason for this is because, in the case of disposing them horizontally to the bottom, a lower part of the gel may be affected by sedimentation of the destained dye.

The body vessel is not limited particularly, as long as the electrodes and the gel container can be disposed therein, and the destaining solution can be contained in an amount that corresponds to an amount of the gel to be destained. The body vessel preferably is provided with a member for helping the disposition of the electrodes and the gel container, such as a spacer or the like for fixing the gel container, for example. A shape of the body vessel is not limited particularly. Also, a material of the body vessel also is not limited particularly, and may be, for example, various kinds of plastics such as acrylic resins. In addition, in the case of using the stirring bar, a hollow for helping the positioning of the stirring bar may be provided on the bottom of the body vessel. The position and the number of the hollow are not limited particularly, and for example, one hollow can be provided at a center part of the body vessel.

The electrode preferably is a plate or mesh electrode having an area equivalent to that of the gel or more, or a line electrode disposed in, for example, a zigzag, waved, circular, spiral shape or the like within a plane having such an area, so as to apply a voltage uniformly to the gel that has the certain area. Moreover, the pair of the electrodes preferably are arranged in parallel. The electrodes may be fixed inside the body vessel, for example, respectively fixed on inner walls and the like that face each other, or may be fixed on substrates that are detachable from the body vessel (hereinafter, also called electrode plates), so as to be separable from the body vessel. A material of the electrode plate is not limited particularly, and may be, for example, the same material as that of the body vessel. A material of the electrode is not limited particularly, and may be, for example, platinum, carbon or the like.

The gel container prevents the sheet-shaped gel from being crimped or broken by being held and sandwiched by the support, and can facilitate positioning the gel between the pair of the electrodes. In addition, if the gel is stored in the gel container after the electrophoresis of the protein, the staining step, the destaining-acceleration step and the destaining step in the staining and destaining method of the present invention can be conducted using the gel container continuously, thereby enhancing operability. Examples of a method for holding the gel by sandwiching it by the support include sandwiching the gel by two sheet-shaped supports, and sandwiching the gel by a two-fold sheet-shaped support. The support preferably is made of a material that does not prevent the electric charge or the destaining in the destaining solution, and examples of the material include: net or mesh fibers; resins; glass; metals; and sheet-shaped non-woven fabrics.

The gel container preferably includes a frame of the support (hereinafter, also called a gel container frame) in order to prevent deformation of the support and the gel. A shape of the gel container frame is not limited particularly, as long as it can maintain the support that sandwiches the gel. Moreover, a configuration where the gel container frame and the support are attached to each other in advance is possible, and another configuration where the gel container frame and the support are independent from each other, and the frame is attached after the support holds the gel by sandwiching it is possible, as well. A material of the gel container frame is not limited particularly, and may be, for example, various kinds of plastics such as acrylic resins.

The electrophoresis destaining device for a gel of the present invention further may include, for example, a gel-staining case or the like that can store a stirring means and the gel container. The stirring means is not limited particularly, and includes, for example, a stirring bar, a stirring device or the like for rotating the stirring bar.

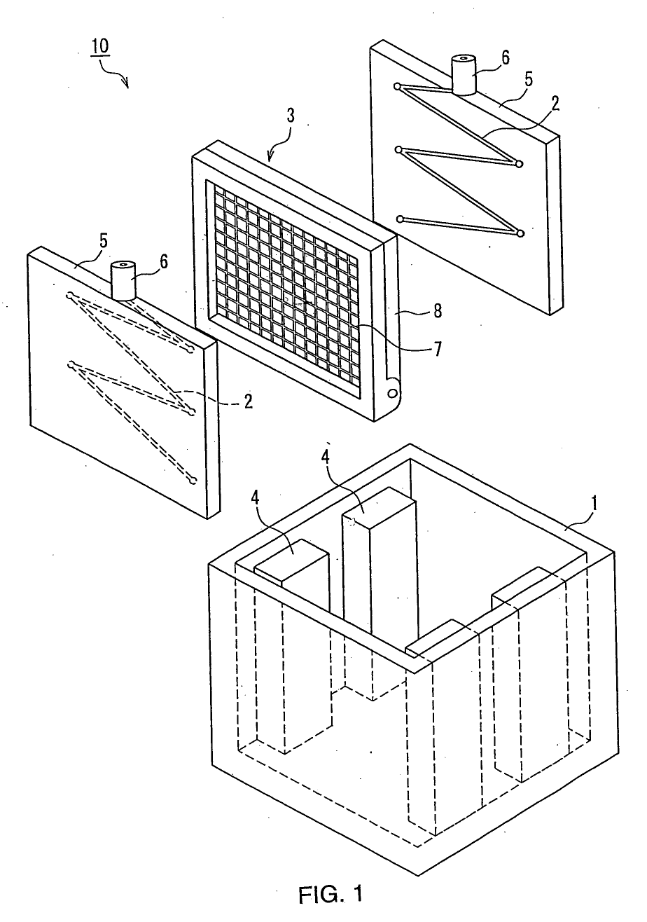

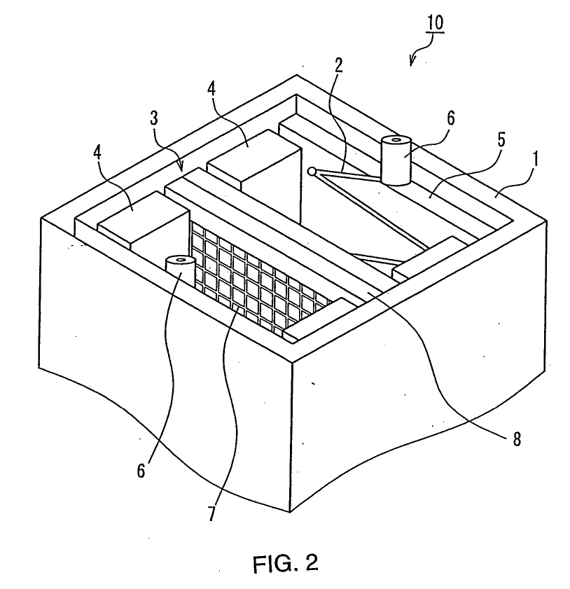

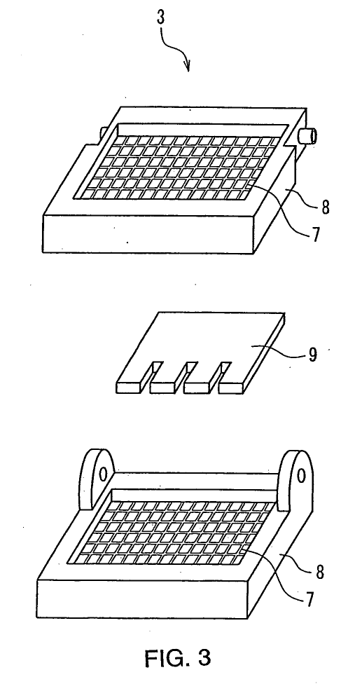

An embodiment of the electrophoresis destaining device for a gel of the present invention will be described with reference to FIGS. 1 to 3. As shown in FIG. 1, the electrophoresis destaining device for a gel of the present invention 10 mainly is composed of: a body vessel 1; electrodes 2; and a gel container 3. Each electrode 2 is fixed on each electrode plate 5, and an end of the electrode 2 is connected to an electrode plug 6. Each electrode plate 5 can be disposed detachably in a space between each spacer 4 and each side wall of the body vessel 1. The gel container 3 is composed of a support 7 and a gel container frame 8, and can be disposed detachably in a space between the spacers 4 of the body vessel 1. FIG. 2 is a view showing the electrophoresis destaining device 10 in which the electrode plates 5 and the gel container 3 are disposed in the body vessel 1. In the figure, common portions are identified by the same reference numerals as in FIG. 1. As shown in the figure, a pair of the electrode plates 5 and the gel container 3 are arranged in parallel to each other via the spacer 4 of the body vessel 1, which enables the uniform destaining by electrophoresis. FIG. 3 shows an example of a configuration of the gel container 3. In the figure, common portions are identified by the same reference numerals as in FIG. 1. The gel container 3 in the figure is composed of: the gel container frame 8 having a hinge portion; and the support 7 fixed to the gel container frame 8, and sandwiches the sheet-shaped gel 9 from above and below so as to dispose the gel 9 perpendicularly to the bottom of the body vessel 1 without deforming the gel 9, as shown in FIG. 2, for example.

Next, the kit for staining and destaining a gel of the present invention will be described. The kit for staining and destaining a gel of the present invention is a kit to be used in the method for staining and destaining a gel of the present invention, and includes: the aqueous solutions to be used in the above-described respective steps; the concentrates thereof; or the powders of their components, and a manual for instructing the method for staining and destaining a gel. In addition, the kit for staining and destaining a gel of the present invention may further include the above-described electrophoresis destaining device.

An example of the kit for staining and destaining a gel of the present invention will be described below, but a configuration of the kit for staining and destaining a gel of the present invention is not limited to this. Examples of the kit for staining and destaining a gel of the present invention include: a kit containing a dye, a solution A and a solution B that will be described below; and a kit containing the dye, the solution A and a solution C that will be described below. The solution A is a solution for preparing the staining solution and the destaining solution, the solution B and the solution C are concentrates of the destaining-acceleration solution, respectively. Respective compositions of the solution A, the solution B and the solution C are as follows:

Dye: CBB R250

Solution A (per 100 mL): acetic acid 50 mL

Solution B (per 100 mL): Tris 50 g, boric acid 3.75 g, EDTA2Na 5 g, pH 9.8

Solution C (per 100 mL): Tris 10 g, boric acid 0.75 g, EDTA2Na 1 g, 5N KOH 5 mL, pH 11.5

An example of the method for staining and destaining a gel of the present invention using these kits and the above-described electrophoresis destaining device will be described.

Firstly, the solutions to be used in the respective steps (the staining solution, the destaining-acceleration solution and the destaining solution) are prepared. The staining solution can be prepared by: adding the solution A to distilled water so that 100 mL of the thus obtained solution contains, for example, 1 mL to 5 mL, and preferably contains 4 mL of the solution A; and then dissolving CBB in the thus obtained solution so that 100 mL of the resultant solution contains, for example, 0.1 g to 0.5 g, and preferably contains 0.25 g of the CBB. The destaining-acceleration solution can be prepared by adding the solution B or the solution C to distilled water so that 100 mL of the resultant solution contains, for example, 0.0.5 mL to 3 mL, and preferably contains 1 mL of the solution B or the solution C. The destaining solution can be prepared by adding the solution A to distilled water so that 100 mL of the resultant solution contains, for example, 1 mL to 5 mL, and preferably contains 4 mL of the solution A.

Next, as shown in FIG. 3, the gel 9 after electrophoresis of protein is stored in the gel container 3, and the gel container 3 holding the gel 9 is immersed in the staining solution, thereby achieving the staining step. A case for containing the staining solution is not limited particularly, as long as it can hold the gel container 3 and the staining solution, and may be, for example, the body vessel of the electrophoresis destaining device. A staining time can be adjusted according to a degree of staining of the gel 9, and can range, for example, about 10 minutes to about 30 minutes.

Then, the staining solution is removed, and the gel container 3 and the case for containing the staining solution are washed with water lightly. Thereafter, the destaining-acceleration solution is added into the case, and the gel container 3 and the case are allowed to stand still or are shaken for, for example, about 10 minutes to about 15 minutes, thereby achieving the destaining-acceleration step.

Finally, for example, as shown in FIG. 2, the gel container 3 is set into the body vessel 1 of the electrophoresis destaining device 10, and the destaining solution is added into the body vessel 1. Then, a voltage ranging, for example, from 100 V to 200 V is applied to the electrode plug 6 so as to effect electrophoresis for about 10 minutes to about 30 minutes, thereby achieving the destaining step.

Next, another example of the method for staining and destaining a gel of the present invention using the kit and the electrophoresis destaining device will be described. This method is not as favorable as the above-described example in terms of the degree of destaining of a dye in the background. But for example, in the case where only a band of protein is required to be checked, this method is useful because it can destain in a shorter period of time. This method is characterized in that the destaining-acceleration step can be omitted.

Firstly, similarly to the above-described method, solutions to be used in the respective steps (a staining solution and a destaining solution) are prepared. In this example, the destaining-acceleration solution is not used. The staining solution is prepared by: adding the solution A to distilled water so that 100 mL of the thus obtained solution contains, for example, 1 mL to 5 mL, and preferably contains 4 mL of the solution A; and then dissolving the CBB in the solution so that 100 mL of the resultant solution contains, for example, 0.1 g to 0.5 g, and preferably contains 0.25 g of the CBB. The destaining solution is prepared by adding the solution A to distilled water so that 100 mL of the resultant solution contains, for example, 1 mL to 5 mL, and preferably contains 4 mL of the solution A.

Next, similarly to the above-described method, the gel after the electrophoresis of protein is stored in the gel container, and is immersed in the staining solution, thereby achieving a staining step. A staining time can be, for example, about 10 minutes.

Then, the staining solution is removed, and the gel container and the case for containing the staining solution are washed with water lightly. Thereafter, the gel container is set into the body vessel, for example, as shown in FIG. 2, so as to effect electrophoresis, thereby achieving a destaining step. For destaining by electrophoresis, for example, a voltage of 200 V can be applied for about 10 minutes. Thus, in this example, since the time until the destaining can be reduced more by omitting the destaining-acceleration step, a band can be found in, for example, about 20 minutes.

As described above, the method for staining and destaining a gel of the present invention is a very simple method that requires quite a short period of time. For example, the method is very useful for SDS-PAGE and native PAGE that often are conducted in biological experiments in a wide range of fields, and also is useful for a case of detecting protein in a gel by staining by a dye after effecting electrophoresis of protein including two-dimensional electrophoresis and the like.

The present invention will be described below further in detail, by way of examples.

### EXAMPLE 1

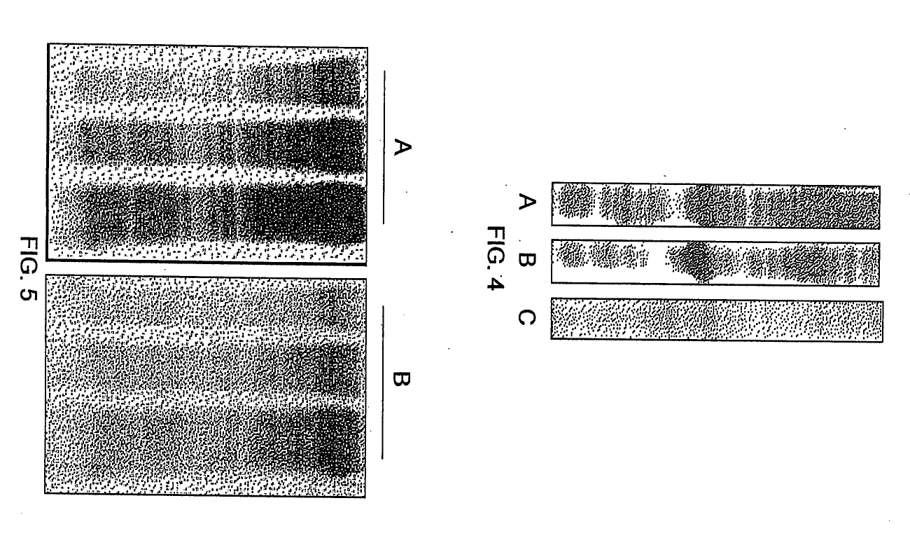

A gel that was prepared by electrophoresing an identical sample by SDS-PAGE was cut into three parts having equal areas. A first part of them was stained by CBB and destaining by the method for staining and destaining a gel of the present invention, a second part thereof was stained and destaining by CBB by a conventional method using methanol, and a third part thereof was stained and destained by CBB by using a commercially available CBB staining kit. Results obtained thereby are shown in FIG. 4. FIG. 4A is a photo showing a result obtained by staining the gel for 20 minutes and destaining the gel by electrophoresis at 100 V for 30 minutes, by the method for staining and destaining a gel of the present invention. FIG. 4B is a photo showing a result obtained by staining the gel for 30 minutes and destaining the gel for 12 hours, by the conventional method. FIG. 4C is a photo showing a result obtained by staining and destaining the gel according to an instruction manual provided by the manufacturer (an operation time thereof was 90 minutes). As shown in FIG. 4, according to the method for staining and destaining a gel of the present invention, the operation time was much shorter than that of the conventional method, and a degree of the staining was superior to that of the kit, and was equivalent or superior to that of the conventional method.

### EXAMPLE 2

Next, proportionality between an amount of the protein in the sample and a density of the dye after the staining and destaining in the staining and destaining method of the present invention was compared with that in the conventional staining and destaining method. SDP-PAGE was performed using three samples that were respectively prepared by adding 2 μL, 5 μL and 10 μL of a protein solution with a protein density of 10 μg/μL. In order to make the same conditions, two units of samples were applied in each of six lanes of the same gels, and the gel was divided into two pieces after the SDP-PAGE. One of these pieces was used in the CBB staining and destaining method of the present invention, and the other piece was used in the conventional CBB staining and destaining method. An example of results obtained thereby is shown in FIGS. 5A and 5B. FIG. 5A is a photo showing a result obtained by performing the CBB staining step for 10 minutes, the destaining-acceleration step for 5 minutes, and the electrophoresis destaining for 10 minutes (at 200 V), by the method for staining and destaining a gel of the present invention. FIG. 5B is a photo showing a result obtained by performing the CBB staining step for 10 minutes and destaining the gel using 25% of methanol and 7.5% of an acetic acid solution for 15 hours, by the conventional method. As shown in FIGS. 5A and 5B, in the method for staining and destaining a gel of the present invention, the proportionality between the amount of the added protein and the density of the CBB after the destaining was high. On the other hand, in the conventional method, even when the amount of the added protein was increased, the density of the CBB that is proportional to the amount of the added protein was not obtained, and thus the proportionality between the amount of the protein and the density of the CBB was low.

As described above, according to the method for staining and destaining a gel of the present invention, for example, a gel in which protein is electrophoresed by SDS-PAGE or the like can be stained and destained easily in a short period of time. Therefore, the present invention is very useful as a tool in the fields of research and development of medical science, pharmaceutical science, biology, bioscience and the like.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A method for staining and destaining a gel, comprising:
a staining step of staining the gel using an acid aqueous solution that contains a dye and does not contain alcohol; and
a destaining step of destaining the dye by electrophoresis by applying a voltage to the gel disposed in an acid aqueous solution that does not contain alcohol.

2. The method for staining and destaining a gel according to claim 1, further comprising a destaining-acceleration step between the staining step and the destaining step, wherein
the destaining-acceleration step is a step of immersing the gel after the staining step in an aqueous solution that has a pH of more than 7 and does not contain alcohol.

3. The method for staining and destaining a gel according to claim 1, wherein each of the aqueous solution in the staining step and the aqueous solution in the destaining step contains acetic acid.

4. The method for staining and destaining a gel according to claim 1, wherein the gel is a polyacrylamide gel.

5. The method for staining and destaining a gel according to claim 1, wherein the gel contains protein, and the dye is at least one dye selected from the group consisting of: Coomassie brilliant blue G250; Coomassie brilliant blue R250; amido black 10B; ponceau 3R; nigrosine; and a dye having an electric charge.

6. The method for staining and destaining a gel according to claim 1, wherein the destaining step further comprises stirring the aqueous solution.

7. An electrophoresis destaining device for a gel to be used in a method for staining and destaining the gel,
the electrophoresis destaining device comprising: a body vessel; a pair of electrodes; and a gel container, wherein
the pair of the electrodes are disposed inside the body vessel, and
the gel container comprises a support for holding the gel by sandwiching the gel, and is disposed detachably between the pair of the electrodes inside the body vessel.

8. The electrophoresis destaining device for a gel according to claim 7, wherein the pair of the electrodes and the gel container are arranged so that a direction of a voltage and a normal line of a surface of the gel may be substantially parallel.

9. A kit to be used in the method for staining and destaining a gel according to claim 1, the kit comprising at least one reagent selected from the group consisting of: the aqueous solutions to be used in the respective steps;
concentrates of the aqueous solutions; and powders of components of the aqueous solutions, and a manual for instructing the method for staining and destaining a gel.

10. The kit for staining and destaining a gel according to claim 9, comprising an electrophoresis destaining device for a gel to be used in a method for staining and destaining the gel, wherein
the electrophoresis destaining device comprises: a body vessel; a pair of electrodes; and a gel container,
the pair of the electrodes are disposed inside the body vessel, and
the gel container comprises a support for holding the gel by sandwiching the gel, and is disposed detachably between the pair of the electrodes inside the body vessel.
